(19) United States
(12) Patent Application Publication
(10) Pub. No.: US 2011/0128346 A1
(43) Pub. Date: Jun. 2, 2011

(54) System of deploying videophone and early warning

(76) Inventors: Vanthach Peter Pham, Gardena, CA (US); Vanlong Joseph Pham, Gardena, CA (US)

(21) Appl. No.: 12/283,509

(22) Filed: Sep. 12, 2008

Related U.S. Application Data
(60) Provisional application No. 60/993,854, filed on Sep. 14, 2007.

(51) Int. Cl. H04N 7/14

(52) U.S. Cl. 348/14.07; 348/14.01; 348/E07.078

(57) ABSTRACT

A device and method for surveillance and early warning detection of undesired activity comprising local videophone and a remote videophone for the purposes of surveying a predetermined area with the local videophone and sending images of the captured information to the remote videophone for real time observation. The method also comprises at will surveillance of the predetermined area by calling the local videophone from the remote videophone to turn the local videophone on, conducting surveillance, and transmitting the captured information, in real time, to the remote videophone. The captured information may be recorded on the remote videophone, by a service provider, or by an emergency response team.

### CROSS-REFERENCE TO RELATED APPLICATION

This patent application claims the benefit of U.S. Provisional Patent Application Ser. No. 60/993,854, entitled “System of Deploying Videophone and Early Warning,” filed Sep. 14, 2007, which application is incorporated in its entirety here by this reference.

### BACKGROUND OF THE INVENTION

1. Technical Field

This invention relates to security systems and surveillance methods.

2. Background Art

Maintaining the safety and security of one's home or vehicle is of the utmost concern for many people. Various security systems have been implemented to deter unwanted entry into a home or a vehicle and prevent the invasion of privacy and the theft of personal property. Security systems generally sound alarms to serve two main functions. First, to notify the owner, the authorities, or the general public that unwanted intrusion is taking place in hopes that someone would notify the authorities before privacy has been breached or property has been stolen. Second, the alarm is intended to frighten the intruder away.

Neither goal, however, is satisfactorily achieved, particularly for car alarms. First, the public, for one reason or another, generally does not respond to another's emergency. A stranger may be afraid to get involved with another person's matter or a stranger may feel that someone else will respond to the emergency. Recognizing this, intruders are undaunted by car alarm systems.

Furthermore, with the prevalence of car alarms, the general public has become desensitized to the alarm. In addition, false alarms from current car alarm systems are so prevalent, that the alarms are repeatedly ignored by the owners and the public. When a traditional car alarm sounds, car owners rarely even check to see if the alarm is theirs let alone whether any criminal activity is afoot.

Thus, car owners are left to themselves to respond to their own emergencies. As such, car alarms have been modified with unique sounds so that one owner can distinguish his alarm from another. However, the presumption is that the car is close enough to the owner so that the alarm can be heard when activated. Often times the car owner is too far away from the vehicle to even hear the alarm. As such, all that is left is an annoying alarm that the public tries to ignore.

In addition, since car alarms rely on the car's electrical system, thieves are able to disable the car alarm before it can be activated. Even if thieves and burglars are unable to deactivate the security system, often times they are able to commit their crime and flee. Owners become aware of the criminal act well after the crime has been committed.

Thus, there is a need for a new type of alarm and surveillance system that immediately notifies the owner of an intrusion without disrupting the public and allows the owner to check the secured area with minimal effort.

### BRIEF SUMMARY OF INVENTION

The present invention is directed towards a system for deploying a videophone triggered by a predetermined activity, such as a burglary, theft, or vandalism. A system of deploying videophones and early warning comprises a local videophone located at a surveillance site and a remote videophone carried by the user or owner. The local videophone captures audio and/or video signals at the surveillance site upon detection of a predetermined activity, such as movement, impact, or sound and automatically calls the remote videophone and transmits the audio and/or video signal to the remote videophone for viewing and listening to the audio and/or video signal in real time by a user. In another embodiment, the transmission of a predetermined activity by the remote phone may be to a phone company, which can then record and transmit the audio and/or video signal to the user. In another embodiment, the transmission of a predetermined activity by the remote phone may be to a voice and/or video mail system that can be accessed by the user by calling the user's voice/video mail number. In another embodiment, a user may call the local videophone from the remote videophone to trigger the capturing and transmission of audio and/or video signals by the local videophone of the surveillance area to the local videophone for listening and/or viewing in real time by the user.

### BRIEF DESCRIPTION OF THE DRAWINGS

FIG. 1 is a flowchart diagram of the overall method of the current invention;

FIG. 2A is a front view of an embodiment of the local videophone;

FIG. 2B is a block diagram depicting a back view of the embodiment shown in FIG. 2A;

FIG. 3A is a front view of an embodiment of the remote videophone; and

FIG. 3B is a block diagram depicting a back view of the embodiment shown in FIG. 3A.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

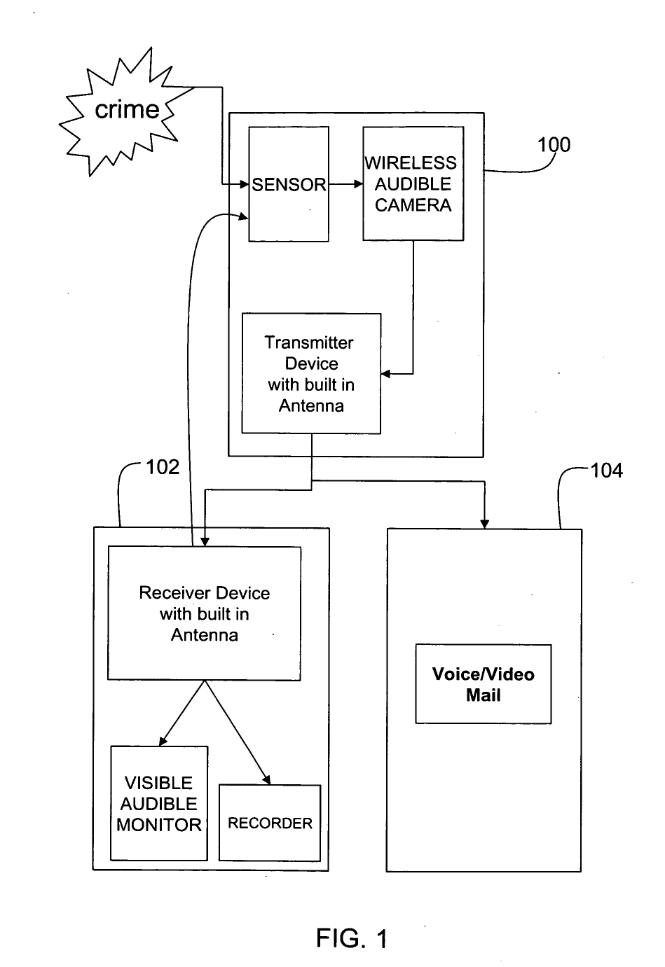

This invention is directed towards remote, immediate, and at-will surveillance of a home, vehicle, or any other location by activating a local videophone 100 installed in the home, the vehicle, or any other location, to observe actual conditions and happenings of that location in real-time from a remote location with a remote videophone 102. Thus, the early warning system of the present invention comprises a local videophone 100 and a remote videophone 102 communicably connected to the local videophone 100. Referring to FIG. 1, in general, a local videophone 100 is automatically activated by a predetermined trigger, such as a crime, an unwanted/unexpected activity within the vicinity of the local videophone 100, or a call from a remote videophone 102. The local videophone 100 captures an image of the activity in the local area and transmits that image of the captured activity, in real time, to the remote videophone 102, a service provider 104, an emergency response team, or any combination thereof. The image may be photographs or a plurality of images making up a video.

Other cell phones, which may have the capability of transmitting videos and photographs, require a user to take the picture or capture the video, record it to the cell phone, then send the images to another phone. Thus, the images are not transmitted in real time. In addition, a first user is required at the phone capturing the images to take the photographs or record the video images and a second user is required to receive the transmitted images or videos. In the present invention, only a single user is required to capture, transmit, and receive images or videos on the remote videophone 102.

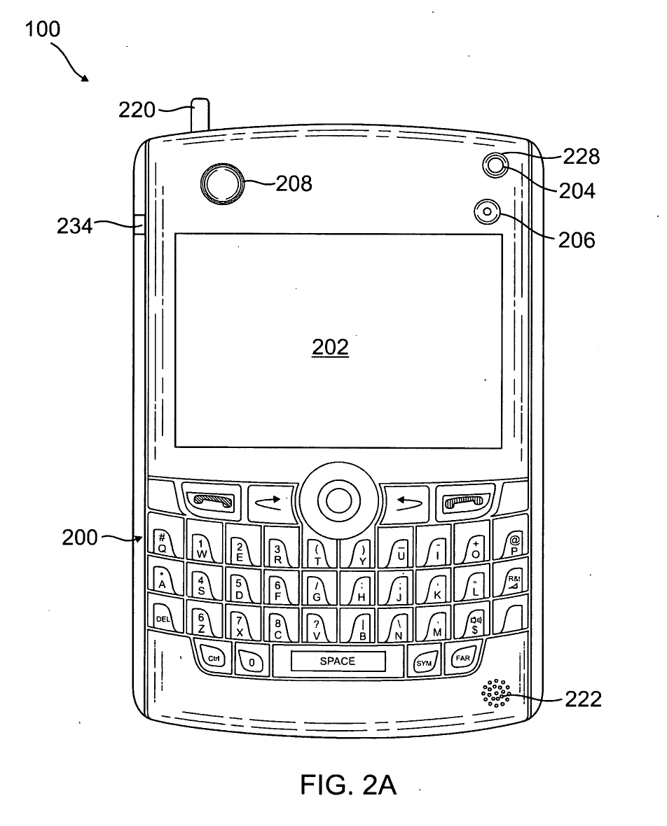

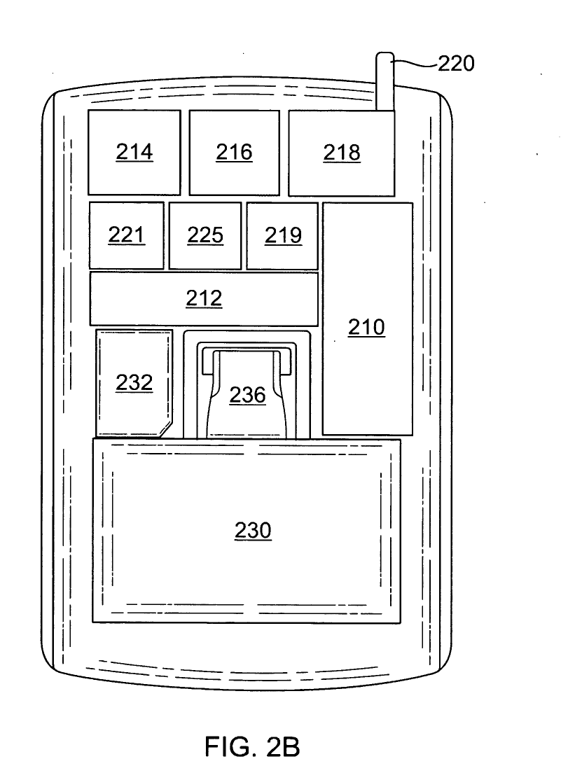

As shown in FIG. 2, the local videophone 100 and the remote videophone 102 may be a standard mobile, cellular phone, or smart phone, which typically includes an input device 200, such as a key pad or microphone, to enter data and make calls, a display device 202 to display current and stored activity and other information on the phone, and an information capture device, such as a camera 204 to capture video signals and a microphone 206 to capture audio information or signals. The camera 204 may be a still camera or a video camera. The videophones 100, 102 may also have a SIM card 236 to store user's telephone numbers and service provider's identification and communication protocol.

Although some features on the local videophone 100 may not be necessary on the remote videophone 102, and some features on the remote videophone 102 may not be necessary on the local videophone 100, it may still be desirable to have identical features on both phones. For example, having identical features allows for interchangeability. In other words, either phone may be used as the local videophone or the remote videophone. In addition, it may be desirable for a user at the local location to survey the remote location. Also, from a manufacturing perspective, implementing existing standard cell phones could save cost by removing the need to create two distinct phones. Thus, although phone features may be described only for the local videophone 100 or only for the remote videophone 102, it is within the scope of this invention to have those features in the other phone. Conversely, there are advantages (such as cost) for making the local videophone with only the minimal required parts.

The local videophone 100 comprises a sensor 208. The sensor 208 may be an optical, mechanical, electrical, motion, or audio sensor to detect any type of signals, such as light, pressure, electrical signals, movement, sound and the like, or any combination thereof. For example, an optical sensor could detect any visual stimuli in the visible light spectrum, such as a dome light being turned on or movement of a visible object and, thereby automatically activate the local videophone 100. Thus, if a perpetrator were to break into a car, opening the door would turn on the dome light which would trigger the sensor 208 and activate the local videophone 100. A mechanical or electrical sensor could detect the physical movement of an object or the electrical signal that could cause the movement of a physical object, such as the unlocking of a door or the opening of a trunk, door, hood, and the like, to activate the local videophone 100. Mechanical or electrical sensors could also be designed to detect a compromise in the integrity of a vehicle such as during vandalism or an accident. In some embodiments, the mechanical sensor could detect movement of the car itself, for example, when a person enters the car or when the car is being driven away. Electrical sensors could also detect an electrical signal from a phone call from the remote videophone 102 to activate the local videophone 100. An audio sensor could detect sound waves propagating through any medium such as solid, liquid, or gas at any frequency, but particularly a frequency detectable by the human ear, such as windows breaking, objects colliding, or talking. Standard car alarms could be modified to activate the local videophone rather than sounding an audible alarm. Any combination of these signals could be used to activate the local videophone 100. Activating the local videophone means to turn the videophone on or begin capture of the visual and auditory information in order to transmit the information to a remote location.

To avoid capturing wanted activities, the sensor 208 can be turned on and off. Turning the sensor 208 on and off may be done on the local videophone 100 directly or by the remote videophone 102. In one embodiment, the sensor 208 is turned on and off by entering predetermined passwords or codes directly on the input device 200 or sending the code to the local videophone 100 from the remote videophone 102. This can be accomplished by calling or sending a text message of the appropriate password or code to the local videophone 100. This feature provides the advantage of longer range for turning the local videophone 100 on and off. Although a switch on the local videophone could be used, this would have the disadvantage of allowing an unauthorized person to turn the local videophone 100 off.

In another embodiment, the sensor 208 may further have the capability of being temporarily disengaged like a typical car alarm system. This would be beneficial when an authorized user wants to enter the premises or a vehicle without activating the local videophone. A temporary disengagement button 250 may be integrated into the remote videophone 102 or to a remote keyless entry device of a vehicle to accomplish this, thereby reducing the number of devices that need to be carried by a user and eliminating the time it would take in sending a call or text. Thus, a user approaching his car can quickly and easily disengage the local videophone 100 with a push of a button on his remote videophone 102 so that he may enter his car without activating the local videophone 100.

Activation of the sensor 208 would automatically turn the local videophone 100 on and start the camera 204 and/or the microphone 206 to capture the video and/or audio signal in a predetermined area. The sensor 208 initiates a signal that travels through an interface unit 212 to the processor, microprocessor, or central processing unit 210 (CPU). The CPU 210 then executes a command to the camera 204 and the microphone 206. The command may be, for example, to turn on the videophone 100, start capturing visual information, start capturing audio information, and/or send a signal to the remote videophone 102 or service provider 104. The video and audio signals captured by the camera 204 and microphone 206 are interfaced by the interface unit 212 and sent to the CPU 210 for processing. The video and audio signals are sent to a video amplifier 214 and an audio amplifier 216, respectively, to amplify the signal. Amplified video and audio data are then sent to an antenna 220 via a transmitting device 218 for transmission to the remote videophone 102. The transmitting device 218 may be a transmitter, a transceiver, a transmitter-receiver, a duplexer, and the like. Concurrently, activation of the local videophone 100 automatically places a call to the remote videophone 102.

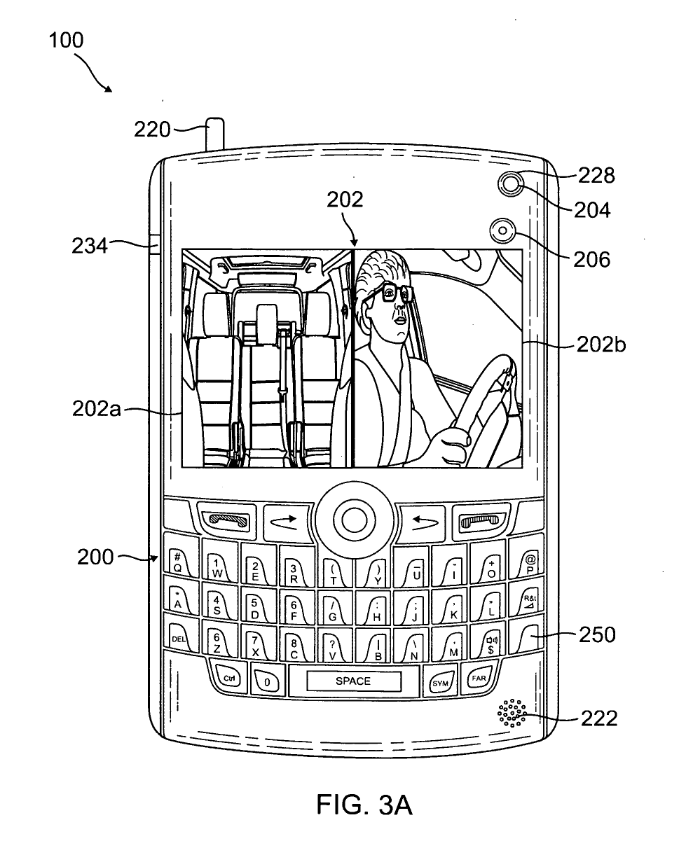

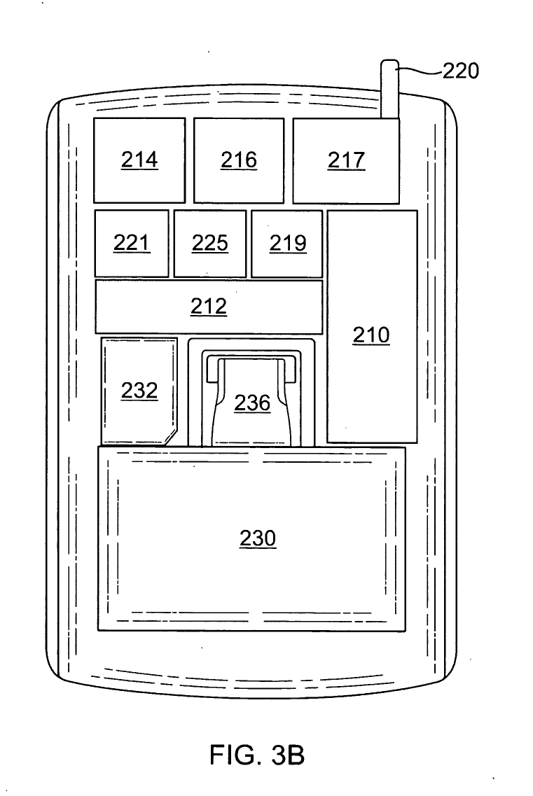

As shown in FIGS. 3A and 3B, at the remote videophone 102, when the user answers the phone the antenna 220 receives transmission of the video and audio information and sends the feed to the receiving device 217. The receiving device 217 may be a receiver, a transceiver, a transmitter-receiver, a duplexer, and the like. The receiving device 217 sends the information to the preamplifier and decoder 219. From the preamplifier and decoder 219, the signal is sent to the CPU 210 and the amplified video signal is then displayed on the display device or monitor 202 and the amplified audio signal is converted to sound and reproduced through a speaker 222 and the activity may be viewed and heard in real time. In some embodiments, the video and audio signal may be monitored by an external monitor 224 or an external speaker 226. The video and audio signal may also be sent to the service provider 104 in conjunction with or in lieu of being sent to the remote videophone 102. The transmitted audio and video signal may be recorded on an electronic storage system 225 simultaneously with the viewing and/or in lieu of the viewing for later use as evidence.

When the local videophone 100 places a call to the remote videophone 102, the user could answer the remote videophone 102 and witness the activities captured by the local videophone 100 in real time. This information could simultaneously be recorded on an electronic storage system 225 on the remote videophone 102. Alternatively, the user or local videophone 100 could send the call to a service provider 104 to record and save the information in an electronic storage system 225 such as a voice/videomail for viewing at a later time. Alternatively, the call can be canceled in the case of a false alarm or an intended action.

The videophones may further be equipped with USB ports 234. USB ports 234 may be used to power the phone and/or transfer the recorded information onto an external CPU.

Thus, in addition to the capability of transmitting sound in real time to a second phone, as in a normal telephonic conversation, the local videophone 100 can transmit video in real time to a second videophone 102. For surveillance purposes, this has the advantage of being able to witness an activity or a crime as it is happening rather than after the fact. By being notified immediately of the activity or crime as it is happening the user can notify the authorities and possibly give a description of the perpetrator; thereby increasing the chances of apprehending the perpetrator.

In addition to the standard methods of activating a sensor, the local videophone 100 can be activated by a call from the remote videophone 102 for at-will surveillance of a predetermined area. For example, a call from the remote videophone 102 to the local videophone 100 provides an electrical signal that activates the sensor 208 to automatically activate the local videophone 100 to capture the audio and/or video information of the surveillance area. In some embodiments, the user could call the local videophone 100 from the remote videophone 102 and enter a password or code to serve as the signal received by the antenna 220 of the local videophone 100 and sent to the receiving device 217. The receiving device 217 sends the received signal to the pre-amplifier and decoder 219 where the signal is recognized as the activation command and sent to the CPU 210. The CPU 210 then sends a command to the microphone and camera to begin capturing the information to send to the remote videophone 102. While connected to the local videophone 100, the user could record the information or have it sent to an electronic storage system 225, such as a voice/videomail system to be saved for later retrieval.

In some embodiments, the remote videophones may comprise a voice/videomail system, such as memory cards, memory sticks, flash drives, read only memory (ROM), random access memory (RAM) and other electronic storage devices 225 on the remote videophone 102. SIM cards 236 may also be used in local and remote videophones 100, 102 to store user's telephone numbers and service provider's identification and communication protocol. The audiovisual information can then be downloaded onto a computer or other recording media and delivered to the proper authorities, for example, for investigation and prosecution of criminal activities. In some embodiments, the voice/videomail system can be a service provided by the service provider 104, such as the phone company. Thus, the phone company can store and retrieve the audiovisual information from its database.

In some embodiments, the camera 204 comprises a wide-angle lens, such as a fisheye lens to increase the field of view of the area of surveillance. The local videophone 100 may further comprise night-vision capabilities 228. For example, the local videophone 100 may utilize image enhancement techniques by amplifying small amounts of light or thermal imaging techniques by detecting infrared light given off as heat. In another embodiment, enhanced intensity range techniques can be utilized to create night vision.

In some embodiments, the camera 204 may be an external camera 300 connected to the videophone 100. This provides added flexibility to the positioning or placement of the camera 204 at the surveillance site.

The local videophone 100 comprises a power source 230. The power source may be a battery or solar energy or both. The battery may be a rechargeable battery. The power may also be derived from the car battery. In embodiments where the local videophone 100 is installed at a residence or a commercial building, regular AC power may be used. A battery can be supplied as backup power in case of a power failure.

The local videophone 100 may further comprise a global positioning system 232 (GPS). When the local videophone 100 is activated, the GPS 232 may simultaneously be activated or the GPS may be activated by the user from a remote location with the remote videophone 102 so that the location of a stolen vehicle can be monitored and conveyed to the authorities.

The local videophone 100 may be placed in any location where surveillance is desired, such as a vehicle, a residence, or a commercial building. The local videophone 100 may be either hidden or in plain view. In one embodiment, the local videophone 100 is placed inside a vehicle to function as an improved and more effective car alarm system. Since the alarm is sent directly to the user as a phone call it will not be ignored. In addition, the general public is not disturbed when the alarm is activated since the alarm is sent directly to the user. Also, since the alarm is in the form of an audiovisual information of the activity surrounding the vehicle, the user can quickly determine whether it is a false alarm or a situation requiring immediate attention.

In some embodiments, the local videophone 100 may be hidden so that an intruder is unaware that his or her activity is being recorded. A hidden local videophone also reduces the likelihood of an intruder disabling the local videophone. In some embodiments, the local videophone 100 is in plain view. Having the local videophone in plain view may deter intruders from even attempting to break into the vehicle.

The local videophone 100 may be installed inside a residence or a commercial building, such as stores, offices, storage facilities and the like. Additional local videophones may be positioned at various points of entry. Unwanted intrusions can activate the sensor 208, place a call to the user, and transmit the audiovisual information to the user. The user can then take immediate action even while on vacation.

The local videophone 100 may also be positioned to monitor outdoor areas. For example, the local videophone may be placed on telephone poles, street lights, or outside of buildings, or any other desired place.

A plurality of local videophones 100 may be installed at the surveillance sight so as to capture various views of the surveillance sight. When a first local videophone is activated it sends a call to the remote videophone for viewing on the display device. When subsequent local videophones are activated calls are sent to the remote videophone. These subsequent calls are placed in queue similar to being placed on hold. An indicator similar to call waiting is displayed on the remote videophone 102 to indicate that there are calls on hold. Simultaneously, the information captured by these local videophones 100 on hold may be recorded for later viewing either on the remote videophone 102 or by the service provider 104. The operator or user has the option of selecting any of the calls on hold from any of the local phones and deemed worthy of immediate attention, and viewing the images in its entirety on the display device.

As shown in FIG. 3A, in some embodiments, the user may select a split-screen viewing mode, where information from different sources, such as one or more local phones is seen simultaneously on the same display device 202. In some embodiments, the first screen 202a may show the location of the local videophone based on GPS data, while the second screen 202b shows a photograph or video of the interior of the vehicle, such as the driver's seat area. The split-screen can be a double screen 202a, 202b, or a quadruple screen, or any other number of screens depending upon the number of local phones being activated. The user can also select one of the multiple split screens to show the selected screen as a full screen.

In addition, a plurality of remote videophones 102 may be called by one or more local videophones 100.

For at will surveillance, the user sends a signal from the remote videophone 102 by, for example, calling or texting the local videophone 100. The signal is received by the local videophone 100 via the antenna 220 to the receiving device 217. The receiving device 217 sends the received signal through the pre-amplifier and decoder 219 to be processed by the CPU 210. If the CPU 210 recognizes the signal as an at-will surveillance trigger, then the CPU 210 sends a command signal to the camera 204 and microphone 206 to turn on. The camera 204 and microphone 206 can capture the video and audio information and transmit that information to the remote videophone 102 and/or the service provider 104.

The data may be stored remotely either on the local videophone 100, the remote videophone 102 or by the service provider 104. The service provider can then provide this data to the user or the authorities. Storing the data remotely rather than locally at the site of the incident prevents the data from being destroyed by the perpetrator who may try to destroy the local videophone 100 if noticed. Hiding or placing the videophone in inconspicuous places would also reduce the possibility that the perpetrator could destroy the local videophone 100.

Thus, a method of surveillance is described comprising detecting a signal at a local videophone, capturing audiovisual information with the local videophone, and transmitting the audiovisual information to a remote party. The method of surveillance further comprises recording the audiovisual information by the remote party. The remote party may be a user of a remote videophone, a service provider, such as a phone company, or an emergency response team or personnel, such as the police, the fire department, the paramedics, and the like. As the name implies, the remote party is at a remote location, or a location other than where the local videophone is located. Obviously, since the remote videophone 102 is mobile, the remote videophone 102 could theoretically be at the same location as the local videophone 100.

Also, a method of surveillance is described comprising calling a local videophone from a remote videophone to activate the local videophone to capture audiovisual information, transmitting the audiovisual information from the local videophone to the remote videophone, and recording the audiovisual information directly onto the remote videophone, a service provider, or an emergency response team.

This method and device may be implemented into current videophones so as to minimize the cost of buying new and separate surveillance units. Also, individuals can now monitor predetermined areas without the need of carrying additional devices. In addition, vehicle manufacturers may pre-install the local videophones into the vehicles, thereby allowing manufacturers to place the local videophones in the most optimal positions to maximize viewing and minimize detection. For example, the local videophone may be installed in inconspicuous locations, such as the dashboard, the rearview mirror, or the dome light of a vehicle. Installation by a manufacturer may also facilitate installation of solar units to power the local videophones by solar energy.

The system of early warning has numerous applicability in surveillance for use by civilians, law enforcement, military, government, and more. The system and device described herein may be employed in vehicles, at homes, borders, and more. This system can replace “nanny-cams,” which only record information for later viewing. This system will allow a user to know when a crime is occurring at the time it occurs.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A videophone and early warning system to transmit a captured activity to a remote location, comprising:
a. a local videophone, comprising:
i. a sensor to automatically detect a signal to activate the local videophone,
ii. a processor to execute a command in response to the signal,
iii. a video camera to capture a visual information, the video camera having a night vision capability,
iv. a microphone to capture an auditory information,
v. a global positioning system (“GPS”) receiver to detect the location information of the local videophone, and
vi. a transmitting device to transmit the visual information, the auditory information, and the location information; and
b. a remote videophone communicably connected to the local videophone, the remote videophone comprising:
i. a receiving device to receive the visual information, the audio information, and the location information transmitted from the local videophone in real time,
ii. an input device to initiate and transmit a communication signal to the local videophone,
iii. a display device to display the visual information and the location information,
iv. a speaker to reproduce the audio information,
v. an electronic storage system to store the visual information and audio information.

2. A videophone and early warning system to transmit an image of a captured activity to a remote location, comprising:
a. a local videophone, comprising:
i. a sensor, and
ii. an information capture device, wherein the sensor automatically detects a signal to turn the information capture device on and transmit the image of the captured activity; and
b. a remote videophone, comprising:
i. a display device, and
ii. a speaker, wherein the remote videophone receives the image of the captured activity and reproduces the image on the display device and the speaker.

3. The videophone and early warning system of claim 2 further comprising a service provider, wherein the service provider receives and electronically stores the image transmitted by the local videophone.

4. The videophone and early warning system of claim 2, wherein the information capture device is a video camera.

5. The videophone and early warning system of claim 3, wherein the video camera comprises a means for night-vision.

6. The videophone and early warning system of claim 3, wherein the video camera comprises a wide-angle lens.

7. The videophone and early warning system of claim 2, wherein the local videophone comprises a solar power module.

8. The videophone and early warning system of claim 2, wherein the sensor detects a signal selected from the group consisting of a visual signal, a mechanical signal, an auditory signal, and an electrical signal.

9. The videophone and early warning system of claim 2, wherein the local videophone further comprises a global positioning system receiver to determine the location of the local videophone.

10. The videophone and early warning system of claim 2, wherein the display device comprises a split-screen function to display a plurality of visual information, wherein each visual information is from a different source.

11. The videophone and early warning system of claim 2, wherein the remote videophone further comprises a remote temporary disengagement button to temporarily disengage the videophone and early warning system.

12. A method of surveillance in real time, comprising:
a. automatically detecting a signal at a local videophone, wherein the signal is selected from the group consisting of an optical signal, a mechanical signal, an electrical signal, and an audio signal;
b. capturing an image of an activity with a local videophone in response to detecting the signal;
c. transmitting the captured image of the activity to a remote location in real time; and
d. recording the activity at the remote location.

13. The method of claim 12, wherein the signal is a call from a remote videophone.

14. The method of claim 12, wherein the remote location is selected from the group consisting of a location of a remote videophone, a service provider, or an emergency response team.

15. The method of claim 12, further comprising:
a. activating a global positioning system in response to detecting the signal; and
b. transmitting a location of the local videophone to a remote party.

16. The method of claim 15, wherein the remote party is selected from the group consisting of a remote videophone user, a service provider, and an emergency response team.

17. The method of claim 15, further comprising simultaneously displaying the captured image transmitted in real time and the location of the local videophone transmitted in real time.
